(19) United States
(12) Patent Application Publication
(10) Pub. No.: US 2021/0024681 A1
(43) Pub. Date: Jan. 28, 2021

(54) METHOD FOR PRODUCING POLYURETHANE SOFT FOAMS

(71) Applicant: Covestro Intellectual Property GmbH & Co. KG, Leverkusen (DE)

(72) Inventors: Matthaeus Gossner, Köln (DE); Veronica-Alina Faerber, Bergisch Gladbach (DE); Lutz Brassat, Leverkusen (DE)

(21) Appl. No.: 16/980,905

(22) PCT Filed: Mar. 19, 2019
(86) PCT No.: PCT/EP2019/056848

§ 371 Date: Sep. 15, 2020

(30) Foreign Application Priority Data
Mar. 22, 2018 (EP) 18163430.4

(51) Int. Cl. C08G 18/12; C08J 9/00; C08G 18/16; C08G 18/18; C08G 18/20; C08G 18/24; C08G 18/44; C08G 18/48; C08G 18/76; C08K 5/10

(52) U.S. Cl. CPC C08G 18/12; C08G 2101/0008; C08J 9/0061; C08G 18/165; C08G 18/1833; C08G 18/2081; C08G 18/244; C08G 18/44; C08G 18/4804; C08G 18/4837; C08G 18/7621; C08K 5/10; C08J 2375/08; C08J 2205/05; C08J 9/0023

(57) ABSTRACT

The invention relates to a method for producing polyurethane soft foams, in particular open-cell polyurethane soft foams based on polyether carbonate polyol and toluylene diisocyanate, wherein the resulting polyurethane soft foams have similar properties to the already known polyurethane soft foams and they are simpler and more sustainable in terms of their production.

The present invention relates to a process for the production of flexible polyurethane foams, in particular of open-cell flexible polyurethane foams based on polyether carbonate polyol and tolylene diisocyanate, where the resulting flexible polyurethane foams have similar properties to the flexible polyurethane foams already known, but are easier and more sustainable to produce.

In order to obtain flexible foams which are based on polyether carbonate polyol and tolylene diisocyanate and have a desired open-cell content, so far two different batches of tolylene diisocyanate mixtures have been used. The first batch is a mixture of 80% by weight of tolylene 2,4-diisocyanate and 20% by weight of tolylene 2,6-diisocyanate obtainable in a simple preparation, this being nitration followed by reduction to the amine and phosgenation. The second mixture consists of 67% by weight of tolylene 2,4-diisocyanate and 33% by weight of tolylene 2,6-diisocyanate and requires a costly and laborious workup in order to obtain the higher content of tolylene 2,6-diisocyanate. This involves tolylene diisocyanate being crystallized out of the mixture in order to increase the proportion of tolylene 2,6-diisocyanate. The higher content of tolylene 2,6-diisocyanate is necessary in order to increase the content of this compound in the reaction for the flexible polyurethane foams. The higher content of tolylene 2,6-diisocyanate is in turn necessary in order to obtain the desired open-cell content.

It was accordingly an object of the present invention to find a system in which the use of the batch of the tolylene diisocyanate mixture which has been worked up by crystallization can be reduced or avoided completely.

In this case, the inventors of the present invention have surprisingly found that this is possible by using specific carboxylic esters of the present invention.

Although WO 2017097729 A1 has already described the general use of esters of monobasic or polybasic carboxylic acids for flexible polyurethane foams based on polyether carbonate polyols, the specific carboxylic esters of the present invention have not been disclosed. Furthermore, it is not apparent to a person skilled in the art from this document that the use of esters of monobasic or polybasic carboxylic acids may be used to reduce or completely avoid the tolylene diisocyanate batch worked up by crystallization. This document merely teaches that the use of esters of monobasic or polybasic carboxylic acids can yield foams having a reduced emission of cyclic propylene carbonate.

The object of the present invention is achieved by a process for the production of flexible polyurethane foams by reacting
component A) containing polyether carbonate polyol A1 and optionally one or more polyether polyols, with the polyether polyols A2 being free of carbonate units, component B):
   B1) catalysts, and optionally
   B2) auxiliaries and additives,
C) water and/or physical blowing agents,
with
D) di- and/or polyisocyanates,
wherein the production is carried out at an index of 90 to 125,
characterized in that the production is effected in the presence of at least one compound E having the formula (I) below:

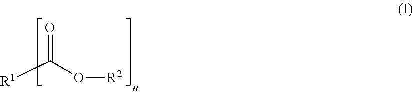

where
R¹ is an aromatic hydrocarbon radical having at least 5 carbon atoms or is a linear, branched, substituted or unsubstituted aliphatic hydrocarbon radical having at least 2 or, if branched, at least 3 carbon atoms;
R² is a linear, branched, substituted or unsubstituted aliphatic hydrocarbon radical; and
n is 1 to 3.

Where it is stated in the present invention that a particular compound or radical may be substituted, this means that substituents known to those skilled in the art are used. It is especially preferable here for one or more hydrogen atoms in the compounds to be replaced by —F, —Cl, —Br, —I, —OH, ═O, —OR³, —OC(═O)R³, —C(═O)—R³, —NH₂, —NHR³, —NR³₂, where R³ represents a linear alkyl radical having 1 to 10 carbon atoms or a branched alkyl radical having 3 to 10 carbon atoms. Particular preference is given to the substituents —F, —Cl, —OR³, —OC(═O)R³ and —C(═O)—R³, where R³ represents a linear alkyl radical having 1 to 10 carbon atoms or a branched alkyl radical having 3 to 10 carbon atoms.

In particular, the present invention relates to:
1. A process for the production of flexible polyurethane foams by reacting
   component A) containing polyether carbonate polyol A1, especially having a hydroxyl number in accordance with DIN 53240-1:2013-06 of from 20 mg KOH/g to 120 mg KOH/g (component A1), and optionally one or more polyether polyols, especially having a hydroxyl number in accordance with DIN 53240-1:2013-06 of from 20 mg KOH/g to 250 mg KOH/g and a content of ethylene oxide of from 0 to 60% by weight (component A2), with the polyether polyols A2 being free of carbonate units, component B):
      B1) catalysts, and optionally
      B2) auxiliaries and additives,
   C) water and/or physical blowing agents,
   with
   D) di- and/or polyisocyanates which contain or consist of tolylene 2,4-diisocyanate and tolylene 2,6-diisocyanate;
   wherein the production is carried out at an index of 90 to 125,
   characterized in that the production is effected in the presence of at least one compound E having the formula (I) below:

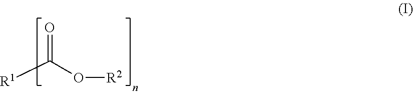

where
R¹ is an aromatic hydrocarbon radical having at least 5 carbon atoms or is a linear, branched, substituted or unsubstituted aliphatic hydrocarbon radical having at least 2 or, if branched, at least 3 carbon atoms;
R² is a linear, branched, substituted or unsubstituted aliphatic hydrocarbon radical; and n is 1 to 3.
2. The process as per aspect 1, characterized in that in formula (I)
   R¹ is an aromatic hydrocarbon radical having at least 6 carbon atoms or is a linear, branched, substituted or unsubstituted aliphatic hydrocarbon radical having at least 3, preferably 3 to 10, carbon atoms;
   R² is a linear, branched, substituted or unsubstituted aliphatic hydrocarbon radical having at least 3, preferably 3 to 16, carbon atoms; and
   n is 1 to 3;
   R¹ is preferably an aromatic hydrocarbon radical having 6 carbon atoms or a linear, branched, substituted or unsubstituted aliphatic saturated hydrocarbon radical having at least 3, preferably 3 to 10, carbon atoms;
   more preferably, the compound is an ester of an optionally substituted C₃₋₁₂ monocarboxylic acid esterified with a linear or branched C₃₋₁₆ alkyl alcohol, in particular hexyl hexanoate;
   or an ester of an optionally substituted C₄₋₁₂, more preferably C₆₋₁₀, dicarboxylic acid esterified with a linear or branched C₃₋₁₆ alkyl alcohol, in particular selected from bis(2-ethylhexyl) adipate and diisodecyl sebacate;
   or an ester of an optionally substituted C₅₋₁₆, more preferably C₆₋₁₀, tricarboxylic acid esterified with a linear or branched C₃₋₁₆ alkyl alcohol, in particular selected from tris(2-ethylhexyl) O-acetylcitrate and tributyl O-acetylcitrate;
   or an ester of a mono-, di- or trisubstituted benzene having a carboxylic acid group and esterified with a linear or branched C₃₋₁₆ alkyl alcohol, in particular esters of C₆₋₁₆ alkyl alcohols and trimesic acid or trimellitic acid, particularly preferably tris(2-ethylhexyl)trimellitate.
3. The process as per aspect 1 or 2, characterized in that component A has the following composition:
   A1 40 to 100 parts by weight of one or more polyether carbonate polyols having a hydroxyl number in accordance with DIN 53240-1:2013-06 of from 20 mg KOH/g to 120 mg KOH/g,
   A2 0 to 60 parts by weight of one or more polyether polyols having a hydroxyl number in accordance with DIN 53240-1:2013-06 of from 20 mg KOH/g to 250 mg KOH/g and a content of ethylene oxide of from 0.10% to 59.0% by weight, preferably 1% to 30% by weight, more preferably 5% to 15% by weight and/or a content of propylene oxide of from 40% to 99.9% by weight, preferably 70% to 99% by weight, more preferably 85% to 95% by weight, with the polyether polyols A2 being free of carbonate units,
   A3 0 to 20 parts by weight, preferably 0.1 to 10 parts by weight, based on the sum of the parts by weight of components A1 and A2, of one or more polyether polyols having a hydroxyl number in accordance with DIN 53240-1:2013-06 of from 20 mg KOH/g to 250 mg KOH/g and a content of ethylene oxide of at least 60% by weight, with the polyether polyols A3 being free of carbonate units,
   A4 0 to 40 parts by weight, preferably 0.1 to 30 parts by weight, based on the sum of the parts by weight of components A1 and A2, of one or more polymer polyols, PUD polyols and/or PIPA polyols,
   A5 0 to 40 parts by weight, preferably 0.1 to 25 parts by weight, based on the sum of the parts by weight of components A1 and A2, of polyols which do not come under the definition of components A1 to A4, wherein all stated parts by weight of components A1, A2, A3, A4, A5 are normalized so that the sum of the parts by weight
   A1+A2 in the composition is 100.
4. The process as per any of the preceding aspects, characterized in that the at least one compound E is used in an amount of 1.0 to 15.0, preferably 2.5 to 10.0, more preferably 5 to 8, parts by weight, wherein all stated parts by weight of compound E are based on the sum of the parts by weight of components A1+A2=100 parts by weight.
5. The process as per any of the preceding aspects, characterized in that, as component B, the following are used:
   B1 catalysts such as
   a) aliphatic tertiary amines, cycloaliphatic tertiary amines, aliphatic amino ethers, cycloaliphatic amino ethers, aliphatic amidines, cycloaliphatic amidines, urea and derivatives of urea and/or
   b) tin(II) salts of carboxylic acids, and
   B2 optionally auxiliaries and additives.
6. The process as per any of the preceding aspects, characterized in that component A comprises:
   A1 65 to 75 parts by weight of one or more polyether carbonate polyols having a hydroxyl number in accordance with DIN 53240-1:2013-06 of from 20 mg KOH/g to 120 mg KOH/g and
   A2 35 to 25 parts by weight of one or more polyether polyols having a hydroxyl number in accordance with DIN 53240 of from 20 mg KOH/g to 250 mg KOH/g and a content of ethylene oxide of from 0.10% to 59.0% by weight, preferably 1% to 30% by weight, more preferably 5% to 15% by weight and/or a content of propylene oxide of from 40% to 99.9% by weight, preferably 70% to 99% by weight, more preferably 85% to 95% by weight, with the polyether polyols A2 being free of carbonate units.
7. The process as per any of the preceding aspects, characterized in that component A1 comprises a polyether carbonate polyol obtainable by copolymerization of carbon dioxide and one or more alkylene oxides in the presence of one or more H-functional starter molecules, wherein the polyether carbonate polyol preferably has a CO₂ content of from 15% to 25% by weight.
8. The process as per any of the preceding aspects, characterized in that component D comprises at least 50% by weight, preferably at least 80% by weight, of tolylene 2,4-diisocyanate and tolylene 2,6-diisocyanate.
9. The process as per any of the preceding aspects, characterized in that component D comprises not more than 21.5% by weight of tolylene 2,6-diisocyanate, based on the total weight of component D, wherein it preferably comprises 18.5% to 21.5% by weight of tolylene 2,6-diisocyanate, based on the total weight of component D, wherein it more preferably comprises 20.0% to 21.5% by weight of tolylene 2,6-diisocyanate, based on the total weight of component D, wherein it most preferably comprises 20.0% by weight of tolylene 2,6-diisocyanate, based on the total weight of component D.
10. The process as per aspect 9, characterized in that tolylene 2,4-diisocyanate and tolylene 2,6-diisocyanate are used in the form of a mixture of at least one batch, preferably two mutually dissimilar batches, wherein the first batch comprises tolylene 2,4-diisocyanate and tolylene 2,6-diisocyanate in a ratio of 80% by weight to 20% by weight and the second batch comprises tolylene 2,4-diisocyanate and tolylene 2,6-diisocyanate in a ratio of 67% by weight to 33% by weight, wherein the proportion of the second batch is not more than 25% by weight, preferably not more than 10% by weight, based on the total weight of the first and the second batch, more preferably wherein solely the two batches are used as component D.
11. Flexible polyurethane foams obtainable by a process as per any of aspects 1 to 10.
12. The flexible polyurethane foams as per aspect 11, characterized in that they are open-cell flexible polyurethane foams.
13. The flexible polyurethane foams as per aspect 11 or 12, characterized in that the flexible polyurethane foams have a foam density in accordance with DIN EN ISO 845:2009-10 of from 45.5 to 60.0 kg/m³, preferably 46.0 to 58.0 kg/m³.
14. The use of the flexible polyurethane foams as per any of aspects 11 to 13 for producing furniture cushioning, textile inserts, mattresses, automobile seats, headrests, armrests, sponges, foam films for use in automobile components such as headliners, door trim, seat rests and structural elements.
15. A two-component system for producing flexible polyurethane foams, containing a first component K1 comprising or consisting of:
   component A) containing polyether carbonate polyol, especially having a hydroxyl number in accordance with DIN 53240-1:2013-06 of from 20 mg KOH/g to 120 mg KOH/g (component A1), and optionally one or more polyether polyols, especially having a hydroxyl number in accordance with DIN 53240-1:2013-06 of from 20 mg KOH/g to 250 mg KOH/g and a content of ethylene oxide of from 0 to 60% by weight (component A2), with the polyether polyols A2 being free of carbonate units,
   B) optionally
   B1) catalysts, and/or
   B2) auxiliaries and additives,
   C) water and/or physical blowing agents, and
   E) a compound having the formula (I) below:

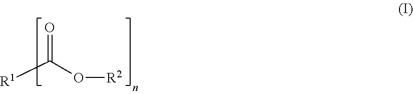

where
R¹ is an aromatic hydrocarbon radical having at least 5 carbon atoms or is a linear, branched, substituted or unsubstituted aliphatic hydrocarbon radical having at least 2 carbon atoms;
R² is a linear, branched, substituted or unsubstituted aliphatic hydrocarbon radical; and
n is 1 to 3,
and a second component K2 comprising or consisting of:
D) di- and/or polyisocyanates which contain or consist of tolylene 2,4-diisocyanate and tolylene 2,6-diisocyanate,
and at least one catalyst, wherein component K1 and component K2 are present in a relative ratio of an isocyanate index of 90 to 125.

Where hydroxyl numbers are disclosed hereinafter as being in accordance with DIN 53240, this is understood as meaning in particular the hydroxyl number in accordance with DIN 53240-1:2013-06.

A further aspect of the invention is a process for the production of flexible polyurethane foams by reacting
A1 ≥40 to ≤100 parts by weight, preferably ≥60 to ≤100 parts by weight, particularly preferably ≥80 to ≤100 parts by weight of one or more polyether carbonate polyols having a hydroxyl number in accordance with DIN 53240 of ≥20 mg KOH/g to ≤120 mg KOH/g,
A2≤60 to ≥0 parts by weight, preferably ≤40 to ≥0.1 parts by weight, particularly preferably ≤20 to ≥5 parts by weight of one or more polyether polyols having a hydroxyl number in accordance with DIN 53240 of ≥20 mg KOH/g to ≤250 mg KOH/g and a content of ethylene oxide of from 0.10% to 59.0% by weight, preferably 1% to 30% by weight, more preferably 5% to 15% by weight and/or a content of propylene oxide of from 40% to 99.9% by weight, preferably 70% to 99% by weight, more preferably 85% to 95% by weight, with the polyether polyols A2 being free of carbonate units,
A3≤20 to ≥0 parts by weight, preferably 0.1 to 10 parts by weight, based on the sum of the parts by weight of components A1 and A2, of one or more polyether polyols having a hydroxyl number in accordance with DIN 53240 of ≥20 mg KOH/g to ≤250 mg KOH/g and a content of ethylene oxide of >60% by weight, with the polyether polyols A3 being free of carbonate units, A4≤40 to ≥0 parts by weight, preferably 0.1 to 10 parts by weight, based on the sum of the parts by weight of components A1 and A2, of one or more polymer polyols, PUD polyols and/or PIPA polyols,
A5≤40 to ≥0 parts by weight, preferably 0.1 to 10 parts by weight, based on the sum of the parts by weight of components A1 and A2, of polyols which do not come under the definition of components A1 to A4,
B optionally
B1) catalysts and/or
B2) auxiliaries and additives,
C water and/or physical blowing agents,
with
D di- and/or polyisocyanates,
wherein the production is carried out at an index of ≥90 to ≤120,
wherein all stated parts by weight of components A1, A2, A3, A4, A5 are normalized so that the sum of the parts by weight of A1+A2 in the composition is 100,
characterized in that production is effected in the presence of component K.

The components A1 to A5 in each case relate to “one or more” of the compounds mentioned. Where a plurality of compounds is used for one component, the stated amount corresponds to the sum of the parts by weight of the compounds.

In a preferred embodiment, component A comprises
A1 ≥65 to ≤75 parts by weight, most preferably ≥68 to ≤72 parts by weight of one or more polyether carbonate polyols having a hydroxyl number in accordance with DIN 53240 of ≥20 mg KOH/g to ≤120 mg KOH/g and preferably a CO2 content of from 15% to 25% by weight, and
A2≤35 to ≥25 parts by weight, most preferably ≤32 to ≥28 parts by weight of one or more polyether polyols having a hydroxyl number in accordance with DIN 53240 of ≥20 mg KOH/g to ≤250 mg KOH/g and a content of ethylene oxide of from 0.10% to 59.0% by weight, preferably 1% to 30% by weight, more preferably 5% to 15% by weight and/or a content of propylene oxide of from 40% to 99.9% by weight, preferably 70% to 99% by weight, more preferably 85% to 95% by weight, with the polyether polyols A2 being free of carbonate units,
wherein component A is preferably free of component A3 and/or A4.

In another embodiment, component A comprises
A1 ≥65 to ≤75 parts by weight, preferably ≥68 to ≤72 parts by weight of one or more polyether carbonate polyols having a hydroxyl number in accordance with DIN 53240 of ≥20 mg KOH/g to ≤120 mg KOH/g and preferably a CO₂ content of from 15% to 25% by weight, and
A2≤35 to ≥25 parts by weight, preferably ≤32 to ≥28 parts by weight of one or more polyether polyols having a hydroxyl number in accordance with DIN 53240 of ≥20 mg KOH/g to ≤250 mg KOH/g and a content of ethylene oxide of from 0.10% to 59.0% by weight, preferably 1% to 30% by weight, more preferably 5% to 15% by weight and/or a content of propylene oxide of from 40% to 99.9% by weight, preferably 70% to 99% by weight, more preferably 85% to 95% by weight, with the polyether polyols A2 being free of carbonate units,
A3≤20 to ≥2 parts by weight, preferably ≤10 to ≥2 parts by weight, based on the sum of the parts by weight of components A1 and A2, of one or more polyether polyols having a hydroxyl number in accordance with DIN 53240 of ≥20 mg KOH/g to ≤250 mg KOH/g and a content of ethylene oxide of >60% by weight, with the polyether polyols A3 being free of carbonate units,
wherein component A is preferably free of component A4.

In a further embodiment, component A comprises
A1 ≥40 to ≤100 parts by weight, preferably ≥60 to ≤100 parts by weight, particularly preferably ≥80 to ≤100 parts by weight, most preferably ≥65 to ≤75 parts by weight of one or more polyether carbonate polyols having a hydroxyl number in accordance with DIN 53240 of ≥20 mg KOH/g to ≤120 mg KOH/g and preferably a CO2 content of from 15% to 25% by weight, and
A2≤60 to ≥0 parts by weight, preferably ≤40 to ≥0 parts by weight, particularly preferably ≤20 to ≥0 parts by weight, most preferably ≤35 to ≥25 parts by weight of one or more polyether polyols having a hydroxyl number in accordance with DIN 53240 of ≥20 mg KOH/g to ≤250 mg KOH/g and a content of ethylene oxide of from 0.10% to 59.0% by weight, preferably 1% to 30% by weight, more preferably 5% to 15% by weight and/or a content of propylene oxide of from 40% to 99.9% by weight, preferably 70% to 99% by weight, more preferably 85% to 95% by weight, with the polyether polyols A2 being free of carbonate units,
A4≤40 to ≥0.01 parts by weight, preferably ≤20 to ≥0.01 parts by weight, particularly preferably ≤20 to ≥1 parts by weight, most preferably ≤20 to ≥2 parts by weight, based on the sum of the parts by weight of components A1 and A2, of one or more polymer polyols, PUD polyols and/or PIPA polyols,
A5≤40 to ≥0 parts by weight, preferably ≤20 to ≥0.01 parts by weight, based on the sum of the parts by weight of components A1 and A2, of polyols which do not come under the definition of components A1 to A4, wherein component A is preferably free of component A3. The stated ranges and preferred ranges of components A1, A2, A4, and A5 are freely combinable with one another here.

The components used in the process according to the invention are described in more detail hereinbelow.

### Component A1

Component A1 comprises a polyether carbonate polyol having a preferred hydroxyl number (OH number) in accordance with DIN 53240-1:2013-06 of ≥20 mg KOH/g to ≤120 mg KOH/g, preferably ≥20 mg KOH/g to ≤100 mg KOH/g, particularly preferably ≥25 mg KOH/g to ≤90 mg KOH/g, which can be obtained by copolymerization of carbon dioxide and one or more alkylene oxides in the presence of one or more H-functional starter molecules, wherein the polyether carbonate polyol preferably has a CO₂ content from 15% to 25% by weight. Component A1 preferably comprises a polyether carbonate polyol obtainable by copolymerization of ≥2% by weight to ≤30% by weight of carbon dioxide and ≥70% by weight to ≤98% by weight of one or more alkylene oxides in the presence of one or more H-functional starter molecules having an average functionality of ≥1 to ≤6, preferably of ≥1 to ≤4, more preferably of ≥2 to ≤3. For the purposes of the invention, the expression “H-functional” refers to a starter compound which has hydrogen atoms which are active in respect of alkoxylation.

The copolymerization of carbon dioxide and one or more alkylene oxides is preferably effected in the presence of at least one DMC catalyst (double metal cyanide catalyst).

The polyether carbonate polyols used according to the invention preferably also possess ether groups between the carbonate groups, which is shown schematically in formula (II). In the scheme according to formula (II), R is an organic radical such as alkyl, alkylaryl or aryl which may in each case also contain heteroatoms such as O, S, Si, etc., and e and f are each an integer. The polyether carbonate polyol shown in the scheme according to formula (II) should be understood as meaning merely that blocks having the structure shown may in principle be present in the polyether carbonate polyol, but the sequence, number and length of the blocks may vary and are not restricted to the polyether carbonate polyol shown in formula (II). In terms of formula (II), this means that the ratio of e/f is preferably from 2:1 to 1:20, particularly preferably from 1.5:1 to 1:10.

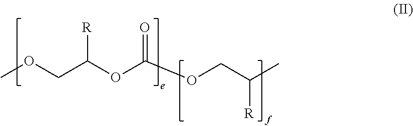

The proportion of incorporated CO₂ (“units derived from carbon dioxide”; “CO₂ content”) in a polyether carbonate polyol can be determined from the evaluation of characteristic signals in the NMR spectrum. The example below illustrates the determination of the proportion of units derived from carbon dioxide in an octane-1,8-diol-started CO₂/propylene oxide polyether carbonate polyol.

The proportion of CO₂ incorporated in a polyether carbonate polyol and the ratio of propylene carbonate to polyether carbonate polyol can be determined by 1H NMR (a suitable instrument is from Bruker, DPX 400, 400 MHz; zg30 pulse program, delay time dl: 10 s, 64 scans). Each sample is dissolved in deuterated chloroform. The relevant resonances in the 1H NMR (based on TMS=0 ppm) are as follows:

Cyclic propylene carbonate (which was formed as a by-product) with a resonance at 4.5 ppm; carbonate resulting from carbon dioxide incorporated in the polyether carbonate polyol with resonances at 5.1 to 4.8 ppm; unreacted propylene oxide (PO) with a resonance at 2.4 ppm; polyether polyol (i.e. without incorporated carbon dioxide) with resonances at 1.2 to 1.0 ppm; the octane-1,8-diol incorporated as starter molecule (if present) with a resonance at 1.6 to 1.52 ppm.

The proportion by weight (in % by weight) of polymer-bound carbonate (LC) in the reaction mixture was calculated by formula (III):

$${LC}^{′} = \frac{[ A ( 5.1 - 4.8 ) - A ( 4.5 ) ] * 102}{D} * 100 \% \qquad ( III )$$

where the value of D (“denominator” D) is calculated by formula (IV):

D=[A(5.1−4.8)−A(4.5)]*102+A(4.5)*102+A(2.4)*58+0.33*A(1.2−1.0)*58+0.25*A(1.6−1.52)*146 (IV)

The following abbreviations are used here:
A(4.5)=area of the resonance at 4.5 ppm for cyclic carbonate (corresponds to a hydrogen atom)
A(5.1-4.8)=area of the resonance at 5.1-4.8 ppm for polyether carbonate polyol and a hydrogen atom for cyclic carbonate
A(2.4)=area of the resonance at 2.4 ppm for free, unreacted PO
A(1.2-1.0)=area of the resonance at 1.2-1.0 ppm for polyether polyol
A(1.6-1.52)=area of the resonance at 1.6 to 1.52 ppm for octane-1,8-diol (starter), if present.

The factor of 102 results from the sum of the molar masses of CO₂ (molar mass 44 g/mol) and of propylene oxide (molar mass 58 g/mol), the factor of 58 results from the molar mass of propylene oxide, and the factor of 146 results from the molar mass of the octane-1,8-diol starter used (if present).

The proportion by weight (in % by weight) of cyclic carbonate (CC) in the reaction mixture was calculated by formula (V):

$${CC}^{′} = \frac{A ( 4.5 ) * 102}{D} * 100 \% \qquad ( V )$$

where the value of D is calculated by formula (IV).

In order to calculate the composition based on the polymer component (consisting of polyether polyol built up from starter and propylene oxide during the activation steps taking place under CO₂-free conditions, and polyether carbonate polyol built up from starter, propylene oxide and carbon dioxide during the activation steps taking place in the presence of CO₂ and during the copolymerization) from the values for the composition of the reaction mixture, the nonpolymeric constituents of the reaction mixture (i.e. cyclic propylene carbonate and any unreacted propylene oxide present) were eliminated mathematically. The proportion by weight of the carbonate repeating units in the polyether carbonate polyol was converted into a proportion by weight of carbon dioxide by means of the factor F=44/(44+58). The value for the CO₂ content in the polyether carbonate polyol is normalized to the proportion of the polyether carbonate polyol molecule which was formed in the copolymerization and in any activation steps in the presence of CO₂ (i.e. the proportion of the polyether carbonate polyol molecule resulting from the starter (octane-1,8-diol, if present) and from the reaction of the starter with epoxide which was added under CO₂-free conditions was not taken into account here).

For example, the preparation of polyether carbonate polyols as per A1 comprises:
(α) initially charging an H-functional starter compound or a mixture of at least two H-functional starter compounds and optionally removing water and/or other volatile compounds by means of elevated temperature and/or reduced pressure (“drying”), with the DMC catalyst being added to the H-functional starter compound or the mixture of at least two H-functional starter compounds before or after drying,
(β) adding a portion (based on the total amount of alkylene oxides used in the activation and copolymerization) of one or more alkylene oxides to the mixture resulting from step (α) to achieve activation, where this portion of alkylene oxide may optionally be added in the presence of CO₂ and where the temperature spike (“hotspot”) which occurs due to the exothermic chemical reaction that follows and/or a pressure drop in the reactor is then awaited in each case, and where step (β) for activation may also be repeated,
(γ) adding one or more of the alkylene oxides and carbon dioxide to the mixture resulting from step (β), wherein the alkylene oxides used in step (β) may be the same as or different from the alkylene oxides used in step (γ).

In general, alkylene oxides (epoxides) having 2 to 24 carbon atoms may be used for preparing the polyether carbonate polyols A1. The alkylene oxides having 2 to 24 carbon atoms are, for example, one or more compounds selected from the group consisting of ethylene oxide, propylene oxide, 1-butene oxide, 2,3-butene oxide, 2-methyl-1,2-propene oxide (isobutene oxide), 1-pentene oxide, 2,3-pentene oxide, 2-methyl-1,2-butene oxide, 3-methyl-1,2-butene oxide, 1-hexene oxide, 2,3-hexene oxide, 3,4-hexene oxide, 2-methyl-1,2-pentene oxide, 4-methyl-1,2-pentene oxide, 2-ethyl-1,2-butene oxide, 1-heptene oxide, 1-octene oxide, 1-nonene oxide, 1-decene oxide, 1-undecene oxide, 1-dodecene oxide, 4-methyl-1,2-pentene oxide, butadiene monoxide, isoprene monoxide, cyclopentene oxide, cyclohexene oxide, cycloheptene oxide, cyclooctene oxide, styrene oxide, methylstyrene oxide, pinene oxide, mono- or polyepoxidized fats as mono-, di- and triglycerides, epoxidized fatty acids, C1-C24 esters of epoxidized fatty acids, epichlorohydrin, glycidol, and derivatives of glycidol, for example methyl glycidyl ether, ethyl glycidyl ether, 2-ethylhexyl glycidyl ether, allyl glycidyl ether, glycidyl methacrylate and epoxy-functional alkoxysilanes, for example 3-glycidyloxypropyltrimethoxysilane, 3-glycidyloxypropyltriethoxysilane, 3-glycidyloxypropyltripropoxysilane, 3-glycidyloxypropylmethyldimethoxysilane, 3-glycidyloxypropylethyldiethoxysilane, 3-glycidyloxypropyltriisopropoxysilane. The alkylene oxides used are preferably ethylene oxide and/or propylene oxide and/or 1,2-butylene oxide, particularly preferably propylene oxide.

In a preferred embodiment of the invention, the proportion of ethylene oxide in the total amount of propylene oxide and ethylene oxide used is ≥0% and ≤90% by weight, preferably ≥0% and ≤50% by weight, and is particularly preferably free of ethylene oxide.

As suitable H-functional starter compounds, it is possible to use compounds having hydrogen atoms which are active in respect of alkoxylation. Groups active in respect of alkoxylation and having active hydrogen atoms are for example —OH, —NH₂ (primary amines), —NH— (secondary amines), —SH and —CO₂H, preferably —OH and —NH₂, particularly preferably —OH. The H-functional starter compound used is for example one or more compounds selected from the group consisting of water, mono- or polyhydric alcohols, polyfunctional amines, polyfunctional thiols, amino alcohols, thio alcohols, hydroxy esters, polyether polyols, polyester polyols, polyester ether polyols, polyether carbonate polyols, polycarbonate polyols, polycarbonates, polyethyleneimines, polyetheramines (for example the products called Jeffamines® from Huntsman, for example D-230, D-400, D-2000, T-403, T-3000, T-5000 or corresponding BASF products, for example Polyetheramine D230, D400, D200, T403, T5000), polytetrahydrofurans (e.g. PolyTHF® from BASF, for example PolyTHF® 250, 650S, 1000, 10005, 1400, 1800, 2000), polytetrahydrofuranamines (BASF product Polytetrahydrofuranamine 1700), polyether thiols, polyacrylate polyols, castor oil, the mono- or diglyceride of ricinoleic acid, monoglycerides of fatty acids, chemically modified mono-, di- and/or triglycerides of fatty acids, and C₁-C₂₄ alkyl fatty acid esters containing an average of at least 2 OH groups per molecule. Examples of C₁-C₂₄ alkyl fatty acid esters containing an average of at least 2 OH groups per molecule are commercial products such as Lupranol Balance® (from BASF AG), Merginol® products (from Hobum Oleochemicals GmbH), Sovermol® products (from Cognis Deutschland GmbH & Co. KG), and Soyol®™ products (from USSC Co.).

Monofunctional starter compounds used may be alcohols, amines, thiols, and carboxylic acids. Monofunctional alcohols that can be used include: methanol, ethanol, 1-propanol, 2-propanol, 1-butanol, 2-butanol, t-butanol, 3-buten-1-ol, 3-butyn-1-ol, 2-methyl-3-buten-2-ol, 2-methyl-3-butyn-2-ol, propargyl alcohol, 2-methyl-2-propanol, 1-t-butoxy-2-propanol, 1-pentanol, 2-pentanol, 3-pentanol, 1-hexanol, 2-hexanol, 3-hexanol, 1-heptanol, 2-heptanol, 3-heptanol, 1-octanol, 2-octanol, 3-octanol, 4-octanol, phenol, 2-hydroxybiphenyl, 3-hydroxybiphenyl, 4-hydroxybiphenyl, 2-hydroxypyridine, 3-hydroxypyridine, 4-hydroxypyridine. Monofunctional amines that may be considered include: butylamine, t-butylamine, pentylamine, hexylamine, aniline, aziridine, pyrrolidine, piperidine, morpholine. As monofunctional thiols, it is possible to use: ethanethiol, 1-propanethiol, 2-propanethiol, 1-butanethiol, 3-methyl-1-butanethiol, 2-butene-1-thiol, thiophenol. Monofunctional carboxylic acids include: formic acid, acetic acid, propionic acid, butyric acid, fatty acids such as stearic acid, palmitic acid, oleic acid, linoleic acid, linolenic acid, benzoic acid, acrylic acid.

Examples of polyhydric alcohols suitable as H-functional starter compounds are dihydric alcohols (for example ethylene glycol, diethylene glycol, propylene glycol, dipropylene glycol, propane-1,3-diol, butane-1,4-diol, butene-1,4-diol, butyne-1,4-diol, neopentyl glycol, pentantane-1,5-diol, methylpentanediols (for example 3-methylpentane-1,5-diol), hexane-1,6-diol; octane-1,8-diol, decane-1,10-diol, dodecane-1,12-diol, bis(hydroxymethyl)cyclohexanes (for example 1,4-bis(hydroxymethyl)cyclohexane), triethylene glycol, tetraethylene glycol, polyethylene glycols, dipropylene glycol, tripropylene glycol, polypropylene glycols, dibutylene glycol, and polybutylene glycols); trihydric alcohols (for example trimethylolpropane, glycerol, trishydroxyethyl isocyanurate, castor oil); tetrahydric alcohols (for example pentaerythritol); polyalcohols (for example sorbitol, hexitol, sucrose, starch, starch hydrolyzates, cellulose, cellulose hydrolyzates, hydroxy-functionalized fats and oils, especially castor oil), and also all products of modification of these abovementioned alcohols having different amounts of ε-caprolactone. In mixtures of H-functional starters, it is also possible to use trihydric alcohols, for example trimethylolpropane, glycerol, trishydroxyethyl isocyanurate, and castor oil.

The H-functional starter compounds may also be selected from the substance class of the polyether polyols, in particular those having a molecular weight Mn in the range from 100 to 4000 g/mol, preferably 250 to 2000 g/mol. Preference is given to polyether polyols formed from repeating ethylene oxide and propylene oxide units, preferably having a proportion of propylene oxide units of from 35% to 100%, particularly preferably having a proportion of propylene oxide units of from 50% to 100%. These may be random copolymers, gradient copolymers, alternating copolymers or block copolymers of ethylene oxide and propylene oxide. Suitable polyether polyols constructed from repeating propylene oxide and/or ethylene oxide units are for example the Desmophen®, Acclaim®, Arcol®, Baycoll®, Bayfill®, Bayflex®, Baygal®, PET® and polyether polyols from Covestro Deutschland AG (e.g. Desmophen® 3600Z, Desmophen® 1900U, Acclaim® Polyol 2200, Acclaim® Polyol 40001, Arcol® Polyol 1004, Arcol® Polyol 1010, Arcol® Polyol 1030, Arcol® Polyol 1070, Baycoll® BD 1110, Bayfill® VPPU 0789, Baygal® K55, PET® 1004, Polyether® S180). Examples of further suitable homopolyethylene oxides are the Pluriol® E brands from BASF SE, examples of suitable homopolypropylene oxides are the Pluriol® P brands from BASF SE, examples of suitable mixed copolymers of ethylene oxide and propylene oxide are the Pluronic® PE or Pluriol® RPE brands from BASF SE.

The H-functional starter compounds may also be selected from the substance class of the polyester polyols, in particular those having a molecular weight Mn in the range from 200 to 4500 g/mol, preferably 400 to 2500 g/mol. The polyester polyols used are at least difunctional polyesters. Polyester polyols preferably consist of alternating acid and alcohol units. The acid components used are, for example, succinic acid, maleic acid, maleic anhydride, adipic acid, phthalic anhydride, phthalic acid, isophthalic acid, terephthalic acid, tetrahydrophthalic acid, tetrahydrophthalic anhydride, hexahydrophthalic anhydride or mixtures of the acids and/or anhydrides mentioned. Alcohol components used are, for example, ethanediol, propane-1,2-diol, propane-1,3-diol, butane-1,4-diol, pentane-1,5-diol, neopentyl glycol, hexane-1,6-diol, 1,4-bis(hydroxymethyl)cyclohexane, diethylene glycol, dipropylene glycol, trimethylolpropane, glycerol, pentaerythritol or mixtures of the alcohols mentioned. When the alcohol components used are dihydric or polyhydric polyether polyols, this affords polyester ether polyols that can likewise serve as starter compounds for preparing the polyether carbonate polyols. If polyether polyols are used to prepare the polyester ether polyols, preference is given to polyether polyols having a number-average molecular weight Mn of 150 to 2000 g/mol.

In addition, the H-functional starter compounds used may be polycarbonate polyols (for example polycarbonate diols), especially those having a molecular weight Mn in the range from 150 to 4500 g/mol, preferably 500 to 2500, which are prepared for example through the reaction of phosgene, dimethyl carbonate, diethyl carbonate or diphenyl carbonate and di- and/or polyfunctional alcohols or polyester polyols or polyether polyols. Examples of polycarbonate polyols can be found, for example, in EP-A 1359177. For example, the polycarbonate diols used may be the Desmophen® C products from Covestro Deutschland AG, for example Desmophen® C 1100 or Desmophen® C 2200.

It is likewise possible to use polyether carbonate polyols as H-functional starter compounds. Polyether carbonate polyols prepared by the method described above are used in particular. These polyether carbonate polyols used as H-functional starter compounds are for this purpose prepared beforehand in a separate reaction step.

Preferred H-functional starter compounds are alcohols of the general formula (VIII),

HO—(CH₂)ₓ—OH (VIII)

wherein x is from 1 to 20, preferably an even number from 2 to 20. Examples of alcohols of formula (VIII) are ethylene glycol, butane-1,4-diol, hexane-1,6-diol, octane-1,8-diol, decane-1,10-diol and dodecane-1,12-diol. Further preferred H-functional starter compounds are neopentyl glycol, trimethylolpropane, glycerol, pentaerythritol, reaction products of the alcohols of formula (II) with ε-caprolactone, for example reaction products of trimethylolpropane with ε-caprolactone, reaction products of glycerol with ε-caprolactone, and reaction products of pentaerythritol with ε-caprolactone. Preference is further given to using, as H-functional starter compounds, water, diethylene glycol, dipropylene glycol, castor oil, sorbitol, and polyether polyols formed from repeating polyalkylene oxide units.

Particularly preferably, the H-functional starter compounds are one or more compounds selected from the group consisting of ethylene glycol, propylene glycol, propane-1,3-diol, butane-1,3-diol, butane-1,4-diol, pentane-1,5-diol, 2-methylpropane-1,3-diol, neopentyl glycol, hexane-1,6-diol, diethylene glycol, dipropylene glycol, glycerol, trimethylolpropane, di- and trifunctional polyether polyols, where the polyether polyol has been formed from a di- or tri-H-functional starter substance and propylene oxide or a di- or tri-H-functional starter substance, propylene oxide and ethylene oxide. The polyether polyols preferably have a number-average molecular weight Mn in the range from 62 to 4500 g/mol and especially a number-average molecular weight Mn in the range from 62 to 3000 g/mol, very particularly preferably a molecular weight of from 62 to 1500 g/mol. The polyether polyols preferably have a functionality of ≥2 to ≤3.

In a preferred embodiment of the invention, the polyether carbonate polyol A1 is obtainable by addition of carbon dioxide and alkylene oxides onto H-functional starter compounds using multi-metal cyanide catalysts (DMC catalysts). The preparation of polyether carbonate polyols by addition of alkylene oxides and CO₂ onto H-functional starter compounds using DMC catalysts is known, for example, from EP-A 0222453, WO-A 2008/013731 and EP-A 2115032.

DMC catalysts are known in principle from the prior art for the homopolymerization of epoxides (see, for example, U.S. Pat. Nos. 3,404,109, 3,829,505, 3,941,849 and 5,158,922). DMC catalysts described, for example, in U.S. Pat. No. 5,470,813, EP-A 700 949, EP-A 743 093, EP-A 761 708, WO-A 97/40086, WO-A 98/16310, and WO-A 00/47649 have very high activity in the homopolymerization of epoxides and make it possible to prepare polyether polyols and/or polyether carbonate polyols at very low catalyst concentrations (25 ppm or less). A typical example is the highly active DMC catalysts described in EP-A 700 949, which comprise not only a double metal cyanide compound (for example zinc hexacyanocobaltate(III)) and an organic complex ligand (for example tert-butanol) but also a polyether having a number-average molecular weight Mn of greater than 500 g/mol.

The DMC catalyst is usually used in an amount of ≤1% by weight, preferably in an amount of ≤0.5% by weight, particularly preferably in an amount of ≤500 ppm and especially in an amount of ≤300 ppm, in each case based on the weight of the polyether carbonate polyol.

In a preferred embodiment of the invention, the polyether carbonate polyol A1 has a content of carbonate groups (“units derived from carbon dioxide”), calculated as CO₂, of ≥2.0% and ≤30.0% by weight, preferably of ≥5.0% and ≤28.0% by weight and particularly preferably of ≥10.0% and ≤25.0% by weight.

In a further embodiment of the process according to the invention, the polyether carbonate polyol(s) according to A1 has/have a hydroxyl number of ≥20 mg KOH/g to ≤250 mg KOH/g and is/are obtainable by copolymerization of ≥2.0% by weight to ≤30.0% by weight of carbon dioxide and ≥70% by weight to ≤98% by weight of propylene oxide in the presence of a hydroxy-functional starter molecule, for example trimethylolpropane and/or glycerol and/or propylene glycol and/or sorbitol. The hydroxyl number can be determined in accordance with DIN 53240.

A further embodiment uses a polyether carbonate polyol A1 containing blocks of formula (II), where the ratio e/f is from 2:1 to 1:20.

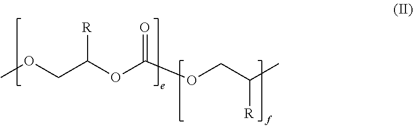

In a further embodiment of the invention, component A1 is used to an extent of 100 parts by weight.

### Component A2

Component A2 comprises polyether polyols preferably having a hydroxyl number in accordance with DIN 53240 of ≥20 mg KOH/g to ≤250 mg KOH/g, by preference of ≥20 to ≤112 mg KOH/g and particularly preferably ≥20 mg KOH/g to ≤80 mg KOH/g and is free from carbonate units.

The compounds according to A2 may be prepared by catalytic addition of one or more alkylene oxides onto H-functional starter compounds.

The alkylene oxides (epoxides) used may be alkylene oxides having 2 to 24 carbon atoms. The alkylene oxides having 2 to 24 carbon atoms are, for example, one or more compounds selected from the group consisting of ethylene oxide, propylene oxide, 1-butene oxide, 2,3-butene oxide, 2-methyl-1,2-propene oxide (isobutene oxide), 1-pentene oxide, 2,3-pentene oxide, 2-methyl-1,2-butene oxide, 3-methyl-1,2-butene oxide, 1-hexene oxide, 2,3-hexene oxide, 3,4-hexene oxide, 2-methyl-1,2-pentene oxide, 4-methyl-1,2-pentene oxide, 2-ethyl-1,2-butene oxide, 1-heptene oxide, 1-octene oxide, 1-nonene oxide, 1-decene oxide, 1-undecene oxide, 1-dodecene oxide, 4-methyl-1,2-pentene oxide, butadiene monoxide, isoprene monoxide, cyclopentene oxide, cyclohexene oxide, cycloheptene oxide, cyclooctene oxide, styrene oxide, methylstyrene oxide, pinene oxide, mono- or polyepoxidized fats as mono-, di- and triglycerides, epoxidized fatty acids, C₁-C₂₄ esters of epoxidized fatty acids, epichlorohydrin, glycidol, and derivatives of glycidol, for example methyl glycidyl ether, ethyl glycidyl ether, 2-ethylhexyl glycidyl ether, allyl glycidyl ether, glycidyl methacrylate and epoxy-functional alkoxysilanes, for example 3-glycidyloxypropyltrimethoxysilane, 3-glycidyloxypropyltriethoxysilane, 3-glycidyloxypropyltripropoxysilane, 3-glycidyloxypropylmethyldimethoxysilane, 3-glycidyloxypropylethyldiethoxysilane, 3-glycidyloxypropyltriisopropoxysilane. The alkylene oxides used are preferably ethylene oxide and/or propylene oxide and/or 1,2-butylene oxide. Particular preference is given to using an excess of propylene oxide and/or 1,2-butylene oxide. The alkylene oxides may be introduced into the reaction mixture individually, in a mixture or successively. The copolymers may be random or block copolymers. If the alkylene oxides are metered in successively, the products (polyether polyols) produced contain polyether chains having block structures.

The H-functional starter compounds have functionalities of ≥2 to ≤6 and are preferably hydroxy-functional (OH-functional). Examples of hydroxy-functional starter compounds are propylene glycol, ethylene glycol, diethylene glycol, dipropylene glycol, butane-1,2-diol, butane-1,3-diol, butane-1,4-diol, hexanediol, pentanediol, 3-methylpentane-1,5-diol, dodecane-1,12-diol, glycerol, trimethylolpropane, triethanolamine, pentaerythritol, sorbitol, sucrose, hydroquinone, catechol, resorcinol, bisphenol F, bisphenol A, 1,3,5-trihydroxybenzene, methylol group-containing condensates of formaldehyde and phenol or melamine or urea. These may also be used in a mixture. The starter compound used is preferably 1,2-propylene glycol and/or glycerol and/or trimethylolpropane and/or sorbitol.

The polyether polyols according to A2 have an ethylene oxide content of ≥0.1% to ≤59.0% by weight, preferably of ≥1% to ≤30% by weight, particularly preferably ≥5% to ≤15% by weight and/or a propylene oxide content of 40% to 99.9% by weight, preferably 70% to 99% by weight, more preferably 85% to 95% by weight. The propylene oxide units are particularly preferably terminal.

### Component A3

Component A3 comprises polyether polyols having a hydroxyl number in accordance with DIN 53240 of ≥20 mg KOH/g to ≤250 mg KOH/g, preferably of ≥20 to ≤112 mg KOH/g, and particularly preferably ≥20 mg KOH/g to ≤80 mg KOH/g.

Component A3 is in principle prepared in an analogous manner to component A2, but with a content of ethylene oxide in the polyether polyol of >60% by weight, preferably >65% by weight being set.

Possible alkylene oxides and H-functional starter compounds are the same as those described for component A2.

However, useful H-functional starter compounds are preferably those having a functionality of ≥3 to ≤6, particularly preferably of 3, so that polyether triols are formed. Preferred starter compounds having a functionality of 3 are glycerol and/or trimethylolpropane, particular preference being given to glycerol.

In a preferred embodiment, component A3 is a glycerol-started trifunctional polyether having an ethylene oxide content of from 68% to 73% by weight and an OH number of from 35 to 40 mg KOH/g.

### Component A4

Component A4 comprises polymer polyols, PUD polyols, and PIPA polyols. Polymer polyols are polyols which contain proportions of solid polymers produced by free-radical polymerization of suitable monomers such as styrene or acrylonitrile in a base polyol, for example a polyether polyol and/or polyether carbonate polyol.

PUD (polyurea dispersion) polyols are, for example, prepared by in-situ polymerization of an isocyanate or an isocyanate mixture with a diamine and/or hydrazine in a polyol, preferably a polyether polyol. The PUD dispersion is preferably prepared by reacting an isocyanate mixture used from a mixture consisting of 75% to 85% by weight of tolylene 2,4-diisocyanate (2,4-TDI) and 15% to 25% by weight of tolylene 2,6-diisocyanate (2,6-TDI) with a diamine and/or hydrazine in a polyether polyol, preferably a polyether polyol and/or polyether carbonate polyol, prepared by alkoxylation of a trifunctional starter (for example glycerol and/or trimethylolpropane), in the case of the polyether carbonate polyol in the presence of carbon dioxide. Methods for preparing PUD dispersions are described, for example, in U.S. Pat. Nos. 4,089,835 and 4,260,530.

PIPA polyols are polyether polyols and/or polyether carbonate polyols modified with alkanolamines, preferably modified with triethanolamine, by polyisocyanate polyaddition, where the polyether (carbonate) polyol has a functionality of from 2.5 to 4 and a hydroxyl number of ≥3 mg KOH/g to ≤112 mg KOH/g (molecular weight from 500 to 18 000). The polyether polyol is preferably “EO capped”, i.e. the polyether polyol has terminal ethylene oxide groups. PIPA polyols are described in detail in GB 2 072 204 A, DE 31 03 757 A1 and U.S. Pat. No. 4,374,209 A.

### Component A5

As component A5, it is possible to use all polyhydroxy compounds known to those skilled in the art which do not come under the definition of components A1 to A4 and preferably have an average OH functionality of >1.5.

These may, for example, be low molecular weight diols (for example ethane-1,2-diol, propane-1,3- or -1,2-diol, butane-1,4-diol), triols (for example glycerol, trimethylolpropane), and tetraols (for example pentaerythritol), polyester polyols, polythioether polyols or polyacrylate polyols, and also polyether polyols or polycarbonate polyols which do not come under the definition of components A1 to A4. It is also possible to use, for example, ethylenediamine- and triethanolamine-started polyethers. These compounds are not counted as compounds according to the definition of component B2.

### Component B

As catalysts according to component B1, preference is given to using
a) aliphatic tertiary amines (for example trimethylamine, tetramethylbutanediamine, 3-dimethylaminopropylamine, N,N-bis(3-dimethylaminopropyl)-N-isopropanolamine), cycloaliphatic tertiary amines (for example 1,4-diaza[2.2.2]bicyclooctane), aliphatic amino ethers (for example bis(dimethylaminoethyl) ether, 2-(2-dimethylaminoethoxy)ethanol and N,N,N-trimethyl-N-hydroxyethylbisaminoethyl ether), cycloaliphatic amino ethers (for example N-ethylmorpholine), aliphatic amidines, cycloaliphatic amidines, urea and derivatives of urea (for example aminoalkylureas, see for example EP-A 0 176 013, in particular (3-dimethylaminopropylamine)urea) and/or
b) tin(II) salts of carboxylic acids.

In particular, the tin(II) salts of carboxylic acids are used, wherein the parent carboxylic acid in each case has from 2 to 24 carbon atoms. The tin(II) salts of carboxylic acids used are, for example, one or more compounds selected from the group consisting of the tin(II) salt of 2-ethylhexanoic acid (i.e. tin(II) 2-ethylhexanoate or tin octoate), the tin(II) salt of 2-butyloctanoic acid, the tin(II) salt of 2-hexyldecanoic acid, the tin(II) salt of neodecanoic acid, the tin(II) salt of isononanoic acid, the tin(II) salt of oleic acid, the tin(II) salt of ricinoleic acid, and tin(II) laurate.

In a preferred embodiment of the invention, at least one tin(II) salt of the formula (IX)

Sn(CxH₂₊₁COO)₂ (IX)

is used, where x is an integer from 8 to 24, preferably 10 to 20, particularly preferably from 12 to 18. In formula (IX), the alkyl chain CₓH₂₊₁ of the carboxylate is particularly preferably a branched carbon chain, i.e. CₓH₂₊₁ is an isoalkyl group.

Most preferably, the tin(II) salts of carboxylic acids used are one or more compounds selected from the group consisting of the tin(II) salt of 2-butyloctanoic acid, i.e. tin(II) 2-butyloctoate, the tin(II) salt of ricinoleic acid, i.e. tin(II) ricinoleate, and the tin(II) salt of 2-hexyldecanoic acid, i.e. tin(II) 2-hexyldecanoate.

In another preferred embodiment of the invention, the component B1 used comprises
B1.1 ≥0.05 to ≤1.5 parts by weight, based on the sum of the parts by weight of components A1 and A2, of urea and/or derivatives of urea and
B1.2 ≥0.03 to ≤1.5 parts by weight, based on the sum of the parts by weight of components A1 and A2, of catalysts other than those of component B1.2, wherein the content of amine catalysts in component B1.2 must not be more than 50% by weight based on component B1.

Component B1.1 comprises urea and derivatives of urea. Examples of derivatives of urea are: aminoalkylureas, for example (3-dimethylaminopropylamine)urea and 1,3-bis[3-(dimethylamino)propyl]urea. It is also possible to use mixtures of urea and urea derivatives. Preference is given to using exclusively urea in component B1.1. Component B1.1 is used in amounts of ≥0.05 to ≤1.5 parts by weight, preferably of ≥0.1 to ≤0.5 parts by weight, particularly preferably of ≥0.25 to ≤0.35 parts by weight, based on the sum of the parts by weight of components A1 to A2.

Component B1.2 is used in amounts of ≥0.03 to ≤1.5 parts by weight, preferably ≥0.03 to ≤0.5 parts by weight, particularly preferably of ≥0.1 to ≤0.3 parts by weight, very particularly preferably of ≥0.2 to ≤0.3 parts by weight, based on the sum of the parts by weight of components A1 to A2.

The content of amine catalysts in component B1.2 is preferably not more than 50% by weight based on component B1.1, particularly preferably not more than 25% by weight based on component B1.1. Component B1.2 is very particularly preferably free of amine catalysts. The catalysts used for component B1.2 may for example be the tin(II) salts of carboxylic acids described above.

Amine catalysts that may optionally be additionally used in small amounts (see above) include: aliphatic tertiary amines (for example trimethylamine, tetramethylbutanediamine, 3-dimethylaminopropylamine, N,N-bis(3-dimethylaminopropyl)-N-isopropanolamine), cycloaliphatic tertiary amines (for example 1,4-diaza[2.2.2]bicyclooctane), aliphatic amino ethers (for example bis(dimethylaminoethyl) ether, 2-(2-dimethylaminoethoxy)ethanol and N,N,N-trimethyl-N-hydroxyethylbisaminoethyl ether), cycloaliphatic amino ethers (for example N-ethylmorpholine), aliphatic amidines, and cycloaliphatic amidines.

The “amine catalysts” specified in B1.2 do not include urea or derivatives thereof.

A nonalkaline medium can preferably be achieved by using urea and/or derivatives of urea as catalysts according to component B1 and not using any amine catalysts.

As component B2, it is possible to use auxiliaries and additives such as
a) surface-active additives such as emulsifiers and foam stabilizers, in particular those having low emissions, for example products of the Tegostab® series,
b) additives such as reaction retarders (for example acidic substances such as hydrochloric acid or organic acid halides), cell regulators (for example paraffins or fatty alcohols or dimethylpolysiloxanes), pigments, dyes, flame retardants (different from component K3; for example ammonium polyphosphate), further stabilizers against aging and weathering effects, antioxidants, plasticizers, fungistatic and bacteriostatic substances, fillers (for example barium sulfate, kieselguhr, carbon black or precipitated chalk) and release agents.

These auxiliaries and additives for optional additional use are described, for example, in EP-A 0 000 389, pages 18-21. Further examples of auxiliaries and additives that may optionally be additionally used according to the invention and details on the use and mode of action of these auxiliaries and additives are described in Kunststoff-Handbuch [Plastics Handbook], volume VII, edited by G. Oertel, Carl-Hanser-Verlag, Munich, 3rd edition, 1993, for example on pages 104-127.

### Component C

As component C, water and/or physical blowing agents are used. Examples of physical blowing agents used as blowing agents are carbon dioxide and/or volatile organic substances. Preference is given to using water as component C.

### Component D

The di- and/or polyisocyanates of the present invention contain or consist of tolylene 2,4-diisocyanate and tolylene 2,6-diisocyanate. These are, for example, polyisocyanates such as those described in EP-A 0 007 502, pages 7-8. Preference is generally given to the readily industrially available polyisocyanates, for example tolylene 2,4- and 2,6-diisocyanate and any desired mixtures of these with isomers (“TDI”); polyphenyl polymethylene polyisocyanates as prepared by aniline-formaldehyde condensation and subsequent phosgenation (“crude MDI”), and polyisocyanates having carbodiimide groups, urethane groups, allophanate groups, isocyanurate groups, urea groups or biuret groups (“modified polyisocyanates”), especially those modified polyisocyanates which derive from tolylene 2,4- and/or 2,6-diisocyanate or from diphenylmethane 4,4′- and/or 2,4′-diisocyanate. Preference is given to using a mixture of tolylene 2,4- and 2,6-diisocyanate with diphenylmethane 4,4′- and/or 2,4′- and/or 2,2′-diisocyanate and polyphenyl polymethylene polyisocyanate (“polycyclic MDI”). Particular preference is given to using tolylene 2,4- and/or 2,6-diisocyanate.

In a further embodiment of the process according to the invention, the isocyanate component D comprises 100% tolylene 2,4-diisocyanate.

In a preferred embodiment of the process according to the invention, the index is ≥90 to ≤120. The index is preferably in the range from ≥100 to ≤115, particularly preferably ≥102 to ≤110.

The index indicates the percentage ratio of the amount of isocyanate actually used to the stoichiometric amount of isocyanate groups (NCO), i.e. the amount calculated for conversion of the OH equivalents.

Index=(amount of isocyanate used):(calculated amount of isocyanate)·100 (XI)

In a preferred aspect, the components are used as follows:
Component A1 at 70% to 100% by weight, in particular 90% by weight or 100% by weight; and/or
Component A2 at 0% to 30% by weight, in particular 10% by weight or 0% by weight, wherein the sum of components A1 and A2 is 100% by weight; and/or
Component B1 at 0.02% to 0.8% by weight, preferably 0.06% to 0.25% by weight, especially preferably 0.22% by weight, based on 100% by weight of A1 and A2; and/or
Component B2 at 0.1% to 6% by weight, preferably 0.2% to 1.2% by weight, especially preferably 1.3% by weight, based on 100% by weight of A1 and A2; and/or
Component C at 0.8% to 3.0% by weight, preferably 1.9% by weight, based on 100% by weight of A1 and A2; and/or
Component E at 2.0% by weight to 12% by weight, preferably 2.0% to 8.0% by weight, based on 100% by weight of A1 and A2.

For production of the flexible polyurethane foams, the reaction components are preferably reacted according to the one-stage process known per se, often using mechanical equipment, for example that described in EP-A 355 000. Details of processing apparatuses which are also suitable according to the invention are described in Kunststoff-Handbuch [Plastics Handbook], volume VII, edited by Vieweg and Hochtlen, Carl-Hanser-Verlag, Munich 1993, for example on pages 139 to 265.

The flexible polyurethane foams may be produced as molded foams or else as slabstock foams, preferably as slabstock foams. The invention accordingly provides a process for the production of the flexible polyurethane foams, the flexible polyurethane foams produced by these processes, the flexible slabstock polyurethane foams/flexible molded polyurethane foams produced by these processes, the use of the flexible polyurethane foams for the production of moldings, and the moldings themselves.

The flexible polyurethane foams obtainable according to the invention find the following uses, for example: furniture cushioning, textile inserts, mattresses, automobile seats, headrests, armrests, sponges, foam films for use in automobile components such as headliners, door trim, seat rests and structural elements.

The flexible foams according to the invention preferably have an apparent density in accordance with DIN EN ISO 845:2009-10 in the range from ≥16 to ≤60 kg/m³, preferably ≥20 to ≤50 kg/m³.

### EXAMPLES

### Component A:

A1-1 CARDYON® LC05 is a polyol mixture consisting of 70% by weight of DESMOPHEN 95LC04 and 30% by weight of ARCOL POLYOL 1108 having an OH number of 54 mg KOH/g; CO₂ content approx. 14%; DESMOPHEN 95LC04: polyether carbonate polyol, glycerol-started; propylene oxide-based; prepared by means of DMC catalysis, OH number: 56 mg KOH/g. ARCOL POLYOL 1108: propylene oxide/ethylene oxide-based polyol; prepared by means of DMC catalysis; starter: glycerol; OH number: 48 mg KOH/g
A1-2 DESMOPHEN 41WB01 is a commercially available ethylene oxide/propylene oxide-based polyol (Covestro AG) having a very high proportion of ethylene oxide groups; starter: glycerol; KOH catalysis; OH number of 37 mg KOH/g

### Component B:

B1-1 Bis[(2-dimethylamino)ethyl]ether (70% by weight) in dipropylene glycol (30% by weight) (Niax® catalyst A-1, Momentive Performance Chemicals, Leverkusen, Germany).
B1-2 1,4-Diazabicyclo[2.2.2]octane (33% by weight) in dipropylene glycol (67% by weight) (Dabco® 33 LV, Evonik, Essen, Germany).
B2-1 Tegostab® B 8244 polyether siloxane-based foam stabilizer (Evonik, Essen, Germany).
B2-2 Tegostab® B 8002 polyether siloxane-based foam stabilizer (Evonik, Essen, Germany).

### Component C: Water

### Component D:

D-1: Mixture of 2,4- and 2,6-TDI in a weight ratio of 80:20 and having an NCO content of from 48% to 48.2% by weight, commercially available as Desmodur T 80 (Covestro AG).
D-2: Mixture of 2,4- and 2,6-TDI in a weight ratio of 67:33 and with an NCO content of 48-48.2% by weight, commercially available as Desmodur T 65 (Covestro AG).

### Component E:

E-1: Diisodecyl sebacate, commercially available as Uniplex DIDS
E-2: Tris(2-ethylhexyl) 0-acetylcitrate, commercially available as Citrofol AHII
E-3: Bis(2-ethylhexyl) adipate, commercially available as Oxsoft DOA

### Production of the Flexible Polyurethane Foams

The starting components are processed in a single-stage process by slabstock foaming under the processing conditions customary for the production of flexible polyurethane foams.

The foam density was determined in accordance with DIN EN ISO 845:2009-10.

The compression hardness (CLD 40%) was determined in accordance with DIN EN ISO 3386-1:2015-10

at a deformation of 40%, 1st and 4th cycle.

Tensile strength and elongation at break were determined in accordance with DIN EN ISO 1798:2008-04.

The compression set (CS 90%) was determined in accordance with DIN EN ISO 1856:2008-01 at 90% deformation.

The compression set (CS 50%) was determined in accordance with DIN EN ISO 1856:2008-01 (22 h, 70° C.) at 50% deformation.

In the table below, comparative examples are indicated as CE and examples according to the invention as IE.

TABLE 1
CE 1 and IE 1 to 6, table continued on next page for IE 7-12; pphp = parts per 100 parts polyol

| | Unit | CE 1 | IE 1 | IE 2 | IE 3 | IE 4 | IE 5 | IE 6 |
|---|---|---|---|---|---|---|---|---|
| CARDYON ® LC05 | [pphp] | 90.00 | 90.00 | 90.00 | 90.00 | 100.00 | 90.00 | 90.00 |
| DESMOPHEN 41WB01 | [pphp] | 10.00 | 10.00 | 10.00 | 10.00 | | 10.00 | 10.00 |
| water (added) | [pphp] | 1.90 | 1.90 | 1.90 | 1.90 | 1.90 | 1.90 | 1.90 |
| Tegostab B 8244 | [pphp] | 1.20 | 1.20 | 1.20 | | | 1.20 | 1.20 |
| Tegostab B 8002 | [pphp] | | | | 1.20 | 1.20 | | |
| Uniplex DIDS | [pphp] | | 5.00 | 8.00 | 8.00 | 8.00 | | |
| Citrofol AHII | [pphp] | | | | | | 5.00 | 8.00 |
| Oxsoft DOA | [pphp] | | | | | | | |
| Dabco 33 LV | [pphp] | 0.10 | 0.10 | 0.10 | 0.10 | 0.10 | 0.10 | 0.10 |
| Niax catalyst A-1 | [pphp] | 0.12 | 0.12 | 0.12 | 0.12 | 0.12 | 0.12 | 0.12 |
| Dabco T-9 | [pphp] | 0.12 | 0.12 | 0.10 | 0.08 | 0.10 | 0.12 | 0.10 |
| (tin octoate) | | | | | | | | |
| DESMODUR T 80 | [pphp] | 13.16 | 19.74 | 26.32 | 23.82 | 26.73 | 19.74 | 26.32 |
| DESMODUR T 65 | [pphp] | 13.16 | 6.58 | | 2.65 | | 6.58 | |
| Water, total | [pphp] | 1.90 | 1.90 | 1.90 | 1.90 | 1.90 | 1.90 | 1.90 |
| INDEX | [—] | 99.0 | 99.0 | 99.0 | 99.0 | 99.0 | 99.0 | 99.0 |
| Mechanical properties | | | | | | | | |
| Foam density | [kg/m³] | 45.1 | 47.7 | 50.5 | 55.5 | 54.60 | 46.8 | 49.1 |
| Compression | [kPa] | 3.5 | 3.2 | 3.38 | 3.69 | 4.55 | 3.36 | 3.76 |
| hardness 40%; | | | | | | | | |
| 1st compression | | | | | | | | |
| Compression | [kPa] | 2.54 | 2.38 | 2.62 | 2.82 | 3.35 | 2.59 | 2.96 |
| hardness 40%; | | | | | | | | |
| 4th compression | | | | | | | | |
| Compression set 50% | [%] | 4.7 | 5.5 | 2.3 | 4.6 | 4.2 | 4.3 | 2.6 |
| Compression set 90% | [%] | 61 | 37.9 | 6.3 | 6.7 | 11.3 | 8.6 | 4.9 |
| Tensile strength | [kPa] | 76 | 68 | 67 | 76 | 65 | 66 | 61 |
| Elongation at break | [%] | 197 | 199 | 175 | 149 | 153 | 193 | 172 |

| | Unit | IE 7 | IE 8 | IE 9 | IE 10 | IE 11 | IE 12 |
|---|---|---|---|---|---|---|---|
| CARDYON ® LC05 | [pphp] | 90.00 | 100.00 | 90.00 | 90.00 | 90.00 | 100.00 |
| DESMOPHEN 41WB01 | [pphp] | 10.00 | | 10.00 | 10.00 | 10.00 | |
| water (added) | [pphp] | 1.90 | 1.90 | 1.90 | 1.90 | 1.90 | 1.90 |
| Tegostab B 8244 | [pphp] | | | 1.20 | 1.20 | | |
| Tegostab B 8002 | [pphp] | 1.20 | 1.20 | | | 1.20 | 1.20 |
| Uniplex DIDS | [pphp] | | | | | | |
| Citrofol AHII | [pphp] | 8.00 | 8.00 | | | | |
| Oxsoft DOA | [pphp] | | | 5.00 | 8.00 | 8.00 | 8.00 |
| Dabco 33 LV | [pphp] | 0.10 | 0.10 | 0.10 | 0.10 | 0.10 | 0.10 |
| Niax catalyst A-1 | [pphp] | 0.12 | 0.12 | 0.12 | 0.12 | 0.12 | 0.12 |
| Dabco T-9 | [pphp] | 0.08 | 0.10 | 0.12 | 0.10 | 0.08 | 0.10 |
| (tin octoate) | | | | | | | |
| DESMODUR T 80 | [pphp] | 23.82 | 26.73 | 19.74 | 26.32 | 23.82 | 26.73 |
| DESMODUR T 65 | [pphp] | 2.65 | | 6.58 | | 2.65 | |
| Water, total | [pphp] | 1.90 | 1.90 | 1.90 | 1.90 | 1.90 | 1.90 |
| INDEX | [—] | 99.0 | 99.0 | 99.0 | 99.0 | 99.0 | 99.0 |
| Mechanical properties | | | | | | | |
| Foam density | [kg/m³] | 57.3 | 52 | 46.8 | 48.7 | 53.5 | 54.6 |
| Compression | [kPa] | 5.14 | 4.55 | 3.41 | 3.19 | 4.14 | 4.78 |
| hardness 40%; | | | | | | | |
| 1st compression | | | | | | | |
| Compression | [kPa] | 3.96 | 3.41 | 2.68 | 2.5 | 3.17 | 3.63 |
| hardness 40%; | | | | | | | |
| 4th compression | | | | | | | |
| Compression set 50% | [%] | 2.2 | 2.4 | 2.5 | 3.2 | 1.9 | 2.7 |
| Compression set 90% | [%] | 3.7 | 3.4 | 4.8 | 5.7 | 3.8 | 13.3 |
| Tensile strength | [kPa] | 83 | 78 | 58 | 64 | 72 | 77 |
| Elongation at break | [%] | 159 | 166 | 171 | 179 | 149 | 168 |

1. A process for the production of flexible polyurethane foams comprising reacting
component A) polyether carbonate polyol A1 and optionally
one or more polyether polyols A2, with the polyether polyols A2 being free of carbonate units,
component B) comprising:
B1) catalysts, and optionally
B2) auxiliaries and additives,
C) water and/or physical blowing agents,
with
D) di- and/or polyisocyanates comprising tolylene 2,4-diisocyanate and tolylene 2,6-diisocyanate;
wherein the production is carried out at an index of 90 to 125,
wherein the production is performed in the presence of at least one compound E having the formula (I) below: 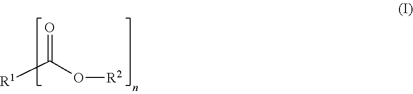
where
R¹ is an aromatic hydrocarbon radical having at least 5 carbon atoms or is a linear, branched, substituted or unsubstituted aliphatic hydrocarbon radical having at least 2 or, if branched, at least 3 carbon atoms;
R² is a linear, branched, substituted or unsubstituted aliphatic hydrocarbon radical; and
n is 1 to 3.

2. The process as claimed in claim 1, wherein in the formula (I)
R¹ is an aromatic hydrocarbon radical having at least 6 carbon atoms or is a linear, branched, substituted or unsubstituted aliphatic hydrocarbon radical having at least 3 carbon atoms;
R² is a linear, branched, substituted or unsubstituted aliphatic hydrocarbon radical having at least 3 carbon atoms; and
n is 1 to 3.

3. The process as claimed in claim 1, wherein component A comprises:
A1 40 to 100 parts by weight of one or more polyether carbonate polyols having a hydroxyl number in accordance with DIN 53240-1:2013-06 of from 20 mg KOH/g to 120 mg KOH/g,
A2 0 to 60 parts by weight of one or more polyether polyols having a hydroxyl number in accordance with DIN 53240-1:2013-06 of from 20 mg KOH/g to 250 mg KOH/g and a content of ethylene oxide of from 0.1% to 59% by weight, with the polyether polyols A2 being free of carbonate units,
A3 0 to 20 parts by weight, based on a sum of the parts by weight of components A1 and A2, of one or more polyether polyols having a hydroxyl number in accordance with DIN 53240-1:2013-06 of from 20 mg KOH/g to 250 mg KOH/g and a content of ethylene oxide of at least 60% by weight, with the polyether polyols A3 being free of carbonate units,
A4 0 to 40 parts by weight, based on the sum of the parts by weight of components A1 and A2, of one or more polymer polyols, PUD polyols, PIPA polyols, or a combination thereof, and
A5 0 to 40 parts by weight, based on the sum of the parts by weight of components A1 and A2, of polyols different from components A1 to A4, wherein all stated parts by weight of components A1, A2, A3, A4, A5 are normalized so that the sum of the parts by weight A1+A2 in the composition is 100.

4. The process as claimed in claim 1, wherein the at least one compound E is used in an amount of 1.0 to 15.0 parts by weight, wherein all stated parts by weight of compound E are based on a sum of the parts by weight of components A1+A2=100 parts by weight.

5. The process as claimed in claim 1, wherein component B comprises:
B1 catalysts comprisinq
a) aliphatic tertiary amines, cycloaliphatic tertiary amines, aliphatic amino ethers, cycloaliphatic amino ethers, aliphatic amidines, cycloaliphatic amidines, urea or derivatives of urea, or a combination thereof, and/or
b) tin(II) salts of carboxylic acids, and
B2 optionally auxiliaries and additives.

6. The process as claimed in claim 1, wherein component A comprises:
A1 65 to 75 parts by weight of one or more polyether carbonate polyols having a hydroxyl number in accordance with DIN 53240-1:2013-06 of from 20 mg KOH/g to 120 mg KOH/g and
A2 35 to 25 parts by weight of one or more polyether polyols having a hydroxyl number in accordance with DIN 53240 of from 20 mg KOH/g to 250 mg KOH/g and a content of ethylene oxide of from 0.1% to 59% by weight, with the polyether polyols A2 being free of carbonate units.

7. The process as claimed in claim 1, wherein component A1 comprises a polyether carbonate polyol obtained by copolymerization of carbon dioxide and one or more alkylene oxides in the presence of one or more H-functional starter molecules.

8. The process as claimed in claim 1, wherein component D comprises at least 50% by weight of tolylene 2,4-diisocyanate and tolylene 2,6-diisocyanate.

9. The process as claimed in claim 1, wherein component D comprises not more than 21.5% by weight of tolylene 2,6-diisocyanate, based on the total weight of component D.

10. The process as claimed in claim 9, wherein tolylene 2,4-diisocyanate and tolylene 2,6-diisocyanate are used in a form of a mixture of at least two mutually dissimilar batches, wherein a first batch comprises tolylene 2,4-diisocyanate and tolylene 2,6-diisocyanate in a ratio of 80% by weight to 20% by weight and a second batch comprises tolylene 2,4-diisocyanate and tolylene 2,6-diisocyanate in a ratio of 67% by weight to 33% by weight, wherein a proportion of the second batch is not more than 25% by weight, based on a total weight of the first and the second batch.

11. A flexible polyurethane foams obtained by the process as claimed in claim 1.

12. The flexible polyurethane foams as claimed in claim 11, wherein the flexible polyurethane foam is an open-cell flexible polyurethane foams.

13. The flexible polyurethane foams as claimed in claim 11, wherein the flexible polyurethane foam has a foam density in accordance with DIN EN ISO 845:2009-10 of from 45.5 to 60.0 kg/m³.

14. (canceled)

15. A two-component system for producing flexible polyurethane foams, comprising
a first component K1 comprising or consisting of:
component A) comprising
A1) polyether carbonate polyol and optionally
A2) one or more polyether polyols, with the polyether polyols A2 being free of carbonate units,
B) optionally
B1) catalysts, and/or
B2) auxiliaries and additives,
C) water and/or physical blowing agents, and
E) a compound having the formula (I) below: 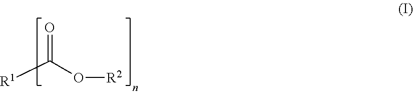
where
R¹ is an aromatic hydrocarbon radical having at least 5 carbon atoms or is a linear, branched, substituted or unsubstituted aliphatic hydrocarbon radical having at least 2 carbon atoms;
R² is a linear, branched, substituted or unsubstituted aliphatic hydrocarbon radical; and
n is 1 to 3,
and a second component K2 comprising:
D) di- and/or polyisocyanates which comprise tolylene 2,4-diisocyanate and tolylene 2,6-diisocyanate,
and at least one catalyst, wherein component K1 and component K2 are present in a relative ratio of an isocyanate index of 90 to 125.
